(19) United States
(12) Patent Application Publication
(10) Pub. No.: US 2017/0243013 A1
(43) Pub. Date: Aug. 24, 2017

(54) MULTI-MODAL ONLINE TRANSACTIONAL PROCESSING SYSTEM

(71) Applicant: USAN, Inc., Norcross, GA (US)

(72) Inventors: Steven J Herlocher, Peachtree Corners, GA (US); Fereydon Shenassa, Alpharetta, GA (US); Steven Pelham Walton, Johns Creek, GA (US)

(21) Appl. No.: 15/046,612

(22) Filed: Feb. 18, 2016

(51) Int. Cl. G06F 21/60; G06Q 20/16; G06Q 20/38; G06Q 20/10; G06Q 30/00; G06Q 20/40

(52) U.S. Cl. CPC G06F 21/606; G06Q 30/016; G06Q 20/405; G06Q 20/382; G06Q 20/10; G06Q 20/16

(57) ABSTRACT

Systems, methods, and computer program products for managing the exchange of sensitive information during a secure communication session. A session instance may establish one or more secure modalities with systems providing sensitive information, and establish one or more open modalities with systems that are participating in the secure communication session, but that may be non-compliant with security standards required to handle the sensitive information. A separate modality manager instance may be created for each modality to selectively control what information is conveyed to each system connected to the session instance based on security rules. The session instance may thereby allow non-sensitive information to be shared with systems connected through open modalities, while preventing these systems from accessing sensitive information received and transmitted through secure modalities.

### BACKGROUND

The invention generally relates to computers and computer systems and, in particular, to methods, systems, and computer program products for Online Transactional Processing (OLTP) systems.

The Payment Card Industry Data Security Standard (PCI-DSS) is an industry standard that defines minimum security requirements which must be put in place by all entities that handle credit card information. Entities subject to PCI-DSS include merchants that accept payment via credit cards, payment processors, acquiring banks, issuing banks, and any other entities that process, store, or transmit cardholder data or sensitive authentication data. PCI-DSS compliance requires that licensed entities only use secure networks and systems for processing cardholder and sensitive authentication data.

Customer contact centers that take payments or work with regulated private information typically incur substantial costs related to compliance with security standards. Compliant contact centers also operate less efficiently than contact centers which do not deal with this type of information. The increased costs and decreased efficiency can be attributed at least in part to the costs of maintaining compliance through system audits, certification of technology, and special processes used to handle sensitive information. Auditing and certification may require companies to hire hundreds or thousands of additional employees, purchase additional computer systems, and implement additional processes.

In addition, contact centers that are standards compliant are typically restricted from using common productivity tools, such as voice and PC screen recording applications, because of the risk these applications would inappropriately capture sensitive information. The inability to use applications that help with coaching, mentoring, and generally improving agent performance thus puts these contact centers at an additional disadvantage as compared to contact centers that do not handle transactions involving sensitive information.

Thus, there is a need for methods, systems, and computer program products that allow contact center agents to assist with processing of transactions involving sensitive information without requiring the contact center to be compliant with security standards.

### SUMMARY

In an embodiment of the invention, an online transactional processing system is provided. The system includes one or more processors and a memory coupled to the processors. The memory stores program code that, when executed by at least one of the one or more processors, causes the online transactional processing system to receive a request to open a secure communication session. The request may identify a first system from which first information including sensitive information is to be received. In response to receiving the request, the online transactional processing system may establish a first modality with the first system, and a second modality with a second system configured to monitor the secure communication session. The online transactional processing system may then receive, from the first system through the first modality, first data conveying the first information, and transmit, through the second modality to the second system, second data that conveys second information relating to the first information without conveying the sensitive information.

In another embodiment of the invention, a method is provided that includes receiving the request to open the secure communication session. The request may identify the first system from which the first information including the sensitive information is to be received. The method may further include establishing the first modality with the first system and the second modality with the second system, and receiving, from the first system through the first modality, first data conveying the first information. The method may then transmit, through the second modality, the second data that conveys the second information relating to the first information without conveying the sensitive information.

In another embodiment of the invention, a computer program product is provided. The computer program product includes a non-transitory computer-readable storage medium including program code. The program code may be configured, when executed by the one or more processors, to cause the one or more processors to receive the request to open the secure communication session. The request may identify the first system from which the first information including the sensitive information is to be received. In response to receiving the request, the program code may cause the one or more processors to establish the first modality with the first system, and the second modality with the second system. The program code may further cause the one or more processors to receive, from the first system through the first modality, the first data conveying the first information, and transmit, through the second modality to the second system, the second data that conveys the second information relating to the first information without conveying the sensitive information.

### BRIEF DESCRIPTION OF THE DRAWINGS

The accompanying drawings, which are incorporated in and constitute a part of this specification, illustrate various embodiments of the invention and, together with the general description of the invention given above, and the detailed description of the embodiments given below, serve to explain the embodiments of the invention.

FIG. 1 is a diagrammatic view of an exemplary operating environment that includes an Online Transactional Processing (OLTP) system, a customer system, an agent system, a mobile network node, a payment system, and a secure information database connected by a network.

FIG. 2 is a diagrammatic view of an exemplary computing system of FIG. 1.

FIG. 3 is a schematic view the OLTP system of FIG. 1 depicting a secure collaboration server, a Shared Business Logic and Control (SBLC) server, a communication server, a context database, and a profile database.

FIG. 4 is a flow chart of a process for managing a secure communication session that may be implemented by the OLTP system of FIG. 3.

FIG. 5 is a flow chart of a sub-process for establishing a secure modality that may be implemented by the process of FIG. 4.

FIGS. 6-8 are diagrammatic views of messages that may be transmitted between the customer system, agent system, payment system, and secure information database of FIG. 1, and the secure collaboration server, SBLC server, communication server, and context database of FIG. 3.

FIGS. 9-16 are diagrammatic views of user interfaces that may be provided by a mobile device or other computing system, and that may be used to initiate and perform a secure transaction involving the OLTP system of FIG. 1.

### DETAILED DESCRIPTION

Embodiments of the invention are directed to systems, methods, and computer program products for securing Personally Identifiable Information (PII), such as payment information, protected health information, and other sensitive information. Embodiments of the invention process this sensitive information using a secure modality for connecting to computer systems that handle sensitive information. The secure modality operates in parallel with an open modality used for communication with computer systems that do not handle sensitive information. Because the sensitive information in the secure modality is not accessible by systems that only handle non-sensitive information, these systems may not be required to comply with security standards, such as imposed by the Health Insurance Portability and Accountability Act (HIPAA), or the Payment Card Industry Data Security Standard (PCI-DSS). This may allow entities that process transactions, such as customer contract centers, to use computer systems that are unencumbered by the need to comply with HIPAA, PCI-DSS, or any other security standards.

In an embodiment of the invention, a contact center system tasked with processing a payment from a customer triggers an Online Transactional Processing (OLTP) system to transmit a one-time use access code or link to a customer system, such as a smart phone, desktop computer, or other computing device. The access code or link may allow the customer to access a web-page, or other suitable interface, that provides a secure modality for entering sensitive information. The customer may then enter sensitive information or make the payment through the web-page, which may be isolated from computer systems used by the contact center. By limiting access to the sensitive information to selected systems, embodiments of the invention may allow the contact center to avoid having to comply with security standards. In another embodiment of the invention, the customer may trigger transmission of the access code or link to their system by simply initiating a transaction that requires sharing of sensitive information.

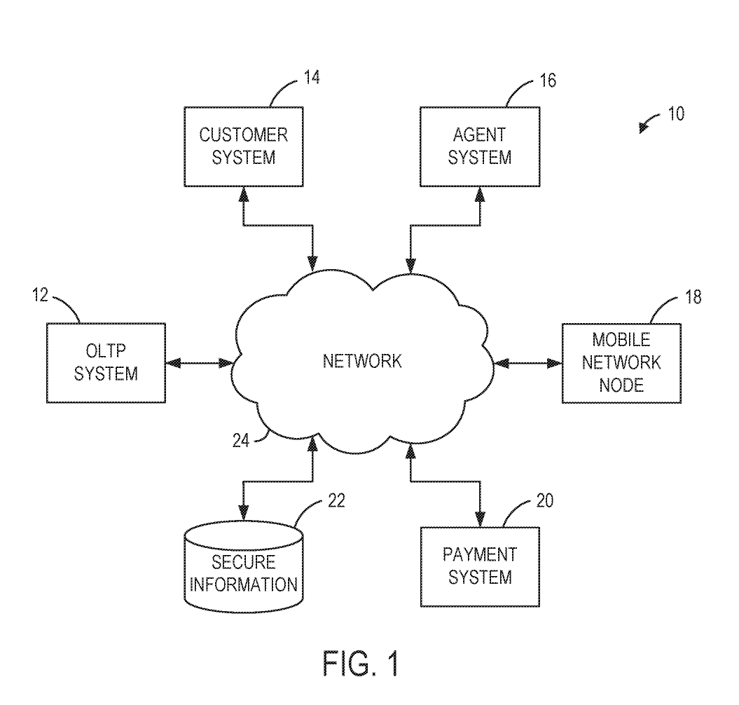

Referring now to FIG. 1, an operating environment 10 in accordance with an embodiment of the invention may include an OLTP system 12, a customer system 14, an agent system 16, a mobile network node 18, a payment system 20, and a secure information database 22. Each of the OLTP system 12, customer system 14, agent system 16, mobile network node 18, payment system 20, and secure information database 22 may communicate through a network 24.

The OLTP system 12 may be configured to handle sensitive information using specialized hardware and/or software, and to adhere to specific security policies and practices against data corruption, destruction, interception, loss, and unauthorized access. In particular, the OLTP system 12 may conform with requirements for handling sensitive information commonly referred to as Personally Identifiable Information (PII). PII may include information about an individual that can be used to distinguish or trace an individual's identity, such as the individual's name, social security number, date and place of birth, mother's maiden name, or biometric records. PII may also include other information that is linked or that is linkable to an individual, such as medical, educational, financial, and employment information.

The OLTP system 12 may be configured to selectively provide information and/or attributes of the information to collaborating systems as needed by controlling what information is shared with each collaborating system. For example, the customer may provide sensitive payment information (e.g., credit card or bank account data) through the customer system 14, and have that information processed by OLTP system 12. During a secure communication session, the agent system 16 may be provided with updates on the customer's progress entering the sensitive information. However, the agent system 16 may be prevented from receiving or displaying any of the sensitive information.

The OLTP system 12 may thereby enable collection of sensitive information from one party (e.g., the customer) with the assistance of another party (e.g., the agent) without exposing the sensitive information to the assisting party. To this end, the OLTP system 12 may collect the sensitive information using a secure modality, and provide progress and/or status information to the assisting party through a separate open modality. The assisting party may thereby provide guidance to the party providing the sensitive information based on the progress of the providing party without having access to the sensitive information itself.

The customer system 14 may comprise a desktop computer, laptop computer, tablet computer, smart phone, and/or any other suitable computing and/or communication device. The customer may use the customer system 14 to communicate with other systems connected to the network 24 using voice, text messaging, email, HyperText Markup Language (HTML), or any other suitable communication protocol and/or medium. The customer system 14 may comprise more than one device (e.g., a land-line phone used in conjunction with a desktop computer) that enable the customer to communicate with other systems and/or agents. In an embodiment of the invention, the customer system 14 may comprise a mobile phone that can be simultaneously used for voice communication with a contact center agent and for entering sensitive information into a a computer system.

The agent system 16 may comprise one or more computing and/or communication devices used by the agent. For example, the a contact center agent may be in voice communication with the customer over a voice channel provided by a land-line or mobile phone, or an application that provides a voice channel using Voice over Internet Protocol (VoIP)). At the same time, the agent may use the agent system 16 to communicate with the OLTP system 12 or other computing system over a separate communication channel. For example, the agent may use a web-browser application to exchange data with a corresponding web-server application running on the OLTP system 12 while communicating with the customer over a separate voice or data channel.

The mobile network node 18 may enable communication between systems connected to the network 24 and a mobile phone connected to a mobile phone system. The mobile network node 18 may comprise, for example, a data gateway or text messaging system that allows systems connected to the Internet to transmit messages or other data to a mobile device.

The payment system 20 may be configured to process forms of payment and/or receive money transfers from customer accounts. Forms of payment may include, for example, credit cards, debit cards, Automated Clearing House (ACH) transactions, online payment systems (e.g., Paypal®), or any other suitable form of payment. The payment system 20 may be configured to exchange data with one or more bank systems (not shown), such as an issuing bank system and/or an acquiring bank system, to authorize payment and transfer funds between accounts.

In the case of an account transfer from a credit or debit card, at the time of the transaction, the payment system 20 may transmit an authorization request to the issuing bank system, which may be determined from the issuer identification number of the card. In response to receiving the authorization request, the issuing bank system may verify the account is valid, and that the account has sufficient funds to cover the amount of the transaction. The issuing bank system may then transmit an authorization response to the payment system 20 indicating that the transaction has been approved, declined, or that more information is required. If more information is required, the payment system 20 may query the OLTP system 12, which may in turn prompt the customer to provide the information using the secure modality.

The secure information database 22 may comprise a database of records that contain sensitive information, such as cardholder data. Cardholder data may include any personally identifiable information associated with a person having a credit or debit card. This data may include, for example the name of the cardholder, a primary account number, an expiration date, and/or a service code. The sensitive information stored in the secure information database 22 may be encrypted to prevent access by unauthorized systems and to comply with PCI-DSS. To facilitate locating records in the secure information database 22, a record locator or other suitable identifier may be associated with each database record in the secure information database.

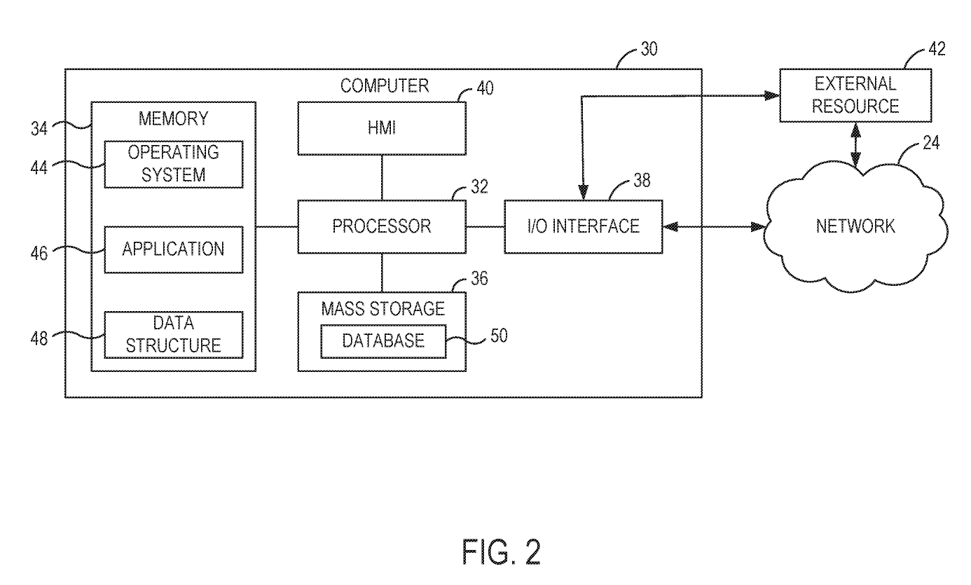

Referring now to FIG. 2, the OLTP system 12, customer system 14, agent system 16, payment system 20, secure information database 22, and network 24 of operating environment 10 may be implemented on one or more computer devices or systems, such as exemplary computer 30. The computer 30 may include a processor 32, a memory 34, a mass storage memory device 36, an input/output (I/O) interface 38, and a Human Machine Interface (HMI) 40. The computer 30 may also be operatively coupled to one or more external resources 42 via the network 24 or I/0 interface 38. External resources may include, but are not limited to, servers, databases, mass storage devices, peripheral devices, cloud-based network services, or any other suitable computer resource that may be used by the computer 30.

The processor 32 may include one or more devices selected from microprocessors, micro-controllers, digital signal processors, microcomputers, central processing units, field programmable gate arrays, programmable logic devices, state machines, logic circuits, analog circuits, digital circuits, or any other devices that manipulate signals (analog or digital) based on operational instructions that are stored in memory 34. Memory 34 may include a single memory device or a plurality of memory devices including, but not limited to, read-only memory (ROM), random access memory (RAM), volatile memory, non-volatile memory, static random access memory (SRAM), dynamic random access memory (DRAM), flash memory, cache memory, or any other device capable of storing data. The mass storage memory device 36 may include data storage devices such as a hard drive, optical drive, tape drive, volatile or non-volatile solid state device, or any other device capable of storing data.

The processor 32 may operate under the control of an operating system 44 that resides in memory 34. The operating system 44 may manage computer resources so that computer program code embodied as one or more computer software applications, such as an application 46 residing in memory 34, may have instructions executed by the processor 32. The processor 32 may also execute the application 46 directly, in which case the operating system 44 may be omitted. The one or more computer software applications may include one or more running instances of an application comprising a server, which may accept requests from, and provide responses to, one or more corresponding client applications. One or more data structures 48 may also reside in memory 34, and may be used by the processor 32, operating system 44, and/or application 46 to store and/or manipulate data.

The I/O interface 38 may provide a machine interface that operatively couples the processor 32 to other devices and systems, such as the network 24 or external resource 42. The application 46 may thereby work cooperatively with the network 24 or external resource 42 by communicating via the I/O interface 38 to provide the various features, functions, applications, processes, or modules comprising embodiments of the invention. The application 46 may also have program code that is executed by one or more external resources 42, or otherwise rely on functions or signals provided by other system or network components external to the computer 30. Indeed, given the nearly endless hardware and software configurations possible, it should be understood that embodiments of the invention may include applications that are located externally to the computer 30, distributed among multiple computers or other external resources 42, or provided by computing resources (hardware and software) that are provided as a service over the network 24, such as a cloud computing service.

The HMI 40 may be operatively coupled to the processor 32 of computer 30 to enable a user to interact directly with the computer 30. The HMI 40 may include video or alphanumeric displays, a touch screen, a speaker, and/or any other suitable audio and visual indicators capable of providing data to the user. The HMI 40 may also include input devices and controls such as an alphanumeric keyboard, a pointing device, keypads, pushbuttons, control knobs, microphones, etc., capable of accepting commands or input from the user and transmitting the entered input to the processor 32.

A database 50 may reside on the mass storage memory device 36, and may be used to collect and organize data used by the various systems and modules described herein. The database 50 may include data and supporting data structures that store and organize the data. In particular, the database 50 may be arranged with any database organization or structure including, but not limited to, a relational database, a hierarchical database, a network database, an object-oriented database, or combinations thereof.

A database management system in the form of a computer software application executing as instructions on the processor 32 may be used to access data stored in records of the database 50 in response to a query. The query may be dynamically determined and executed by the operating system 44, other applications 46, or one or more modules. Although embodiments of the invention may be described herein using relational, hierarchical, network, object-oriented, or other database terminology in specific instances, it should be understood that embodiments of the invention may use any suitable database management model, and are not limited to any particular type of database.

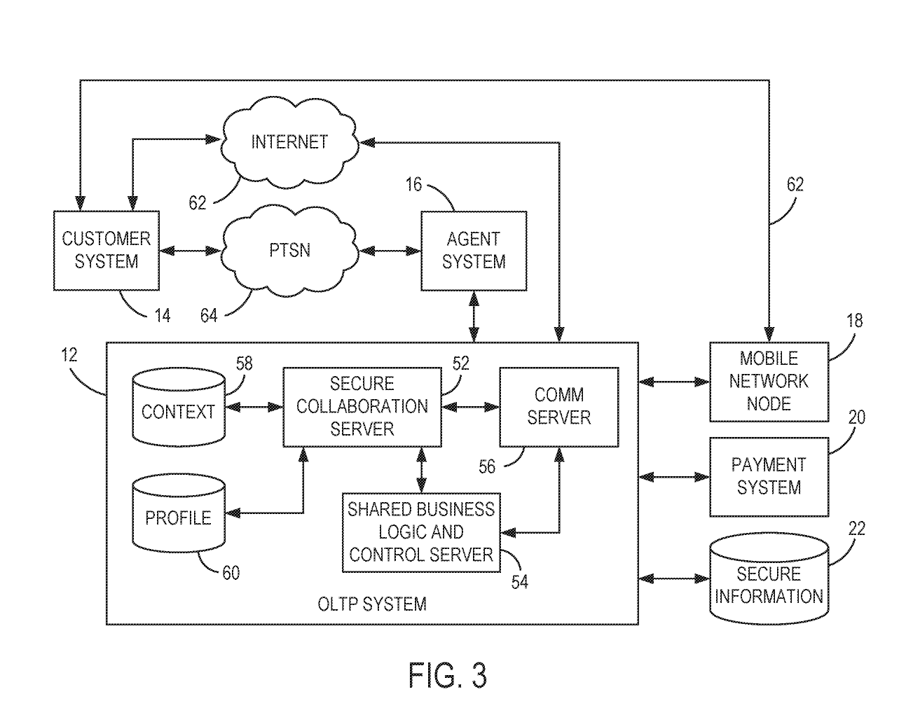

Referring now to FIG. 3, the OLTP system 12 may comprise a secure collaboration server 52, a Shared Business Logic and Control (SBLC) server 54, a communication server 56, a context database 58, and a profile database 60. Each of these servers/databases may be provided or hosted on separate platforms, or by a single platform. The OLTP system 12 may be configured to manage secure communication sessions involving one or more systems that work collaboratively with the OLTP system 12 to process a transaction. For example, in an embodiment of the invention, the collaborating systems may include one or more of the customer system 14, the agent system 16, the payment system 20, and the secure information database 22. The OLTP system 12 may monitor the status of the secure communication session, control access to the session, and relay selected information about the session state and context securely to multiple parties involved in the collaboration. Exemplary session statuses may include session identifier created, session identifier transmitted, session pending initiation, session initiated, session in progress, session completed, and session expired. In an embodiment of the invention, a contact center agent may be notified when the customer has received a text message sent by the agent, has clicked a session link embedded in the message, has opened a mobile web browser session, and has started to enter data.

The secure collaboration server 52 may be configured to open and maintain secure communication sessions, and establish, manage, and communicate with one or more collaborating systems for that session. The secure collaboration server 52 may also manage and control access to the context database 58 and profile database 60. A session instance may be created on the secure collaboration server 52 for each secure communication session being managed. Each session instance may be configured to allow parties that provide a valid access code or link to join the secure communication session, subject to security rules enforced by the SBLC server 54. The session instance may allow certain systems to continue to participate in the secure communication session after one or more other systems have disconnected from the session. For example, a session instance may remain active to allow the customer to complete entry of payment information through the secure modality after the agent system 16 has dropped out of the secure communication session. The secure collaboration server 52 may also allow the session instance to persist for a controlled amount of time after some systems have disconnected so that the remaining systems can to continue to interact with the secure communication session to complete a transaction.

The SBLC server 54 may provide business logic and control for managing the information that is collected from and transmitted to each collaborating system through the secure collaboration server 52. The SBLC server 54 may control what data is stored in the secure session context, and what information or attributes about that information is shared with each collaborating system participating in a secure communication session. In an embodiment of the invention, a modality manager instance may be created by the SBLC server 54 each time a collaborating system joins the secure communication session. Each modality manager instance may be configured to control data flow to and from its respective collaborating system according to the security rules for that system and/or user. The SBLC server 54 may thereby independently control data flow to each collaborating system participating in the secure communication session.

The communication server 56 may manage communication between the OLTP system 12 and external systems. To this end, the communication server 56 may provide one or more web servers, email servers, text messaging servers, HTTP Proxy servers, gateways, or any other type of server or application that is used to provide or establish communications between the OLTP system 12 and an external system.

The context database 58 may store a session context for each secure communication session. This session context may be stored, for example, in a session context record. The profile database 60 may store customer profile information, such as preferences for customer who have previously participated in a secure communication session. This profile information may include a opt-in or opt-out flag that may be used to determine if the customer is has agreed to participate in secure communication sessions. The profile database 60 may also be used to store rules regarding which systems should have access to sensitive information, and what types of sensitive information they may have access to.

In response to receiving a request to establish a secure communication session, the OLTP system 12 may establish one or more communication channels, or modalities, between the collaborating systems. These modalities may include communication channels established between the OLTP system 12 and the customer system 14 via one or more of the mobile network node 18, communication server 56, and/or Internet 62. Communication channels may also be established between the OLTP system 12 and agent system 16, between the OLTP system 12 and the payment system 20, between the OLTP system 12 and the secure information database 22, and/or between the OLTP system 12 and any other collaborating system. One or more of the communication channels may comprise a Virtual Private Network (VPN) or other secure method for communicating that enables the collaborating systems to send and receive data across shared or public network nodes as if they were directly connected to the OLTP system 12.

One collaborating system may communicate with the another collaborating system using more than one communication channel. For example, in an embodiment of the invention, the customer system 14 may be connected to the agent system 16 by a voice channel over the PTSN 64, and to the communication server 56 by an Internet Protocol (IP) channel over the Internet 62. The voice channel may enable the customer to simultaneously interact with an Interactive Voice Response (IVR) system or the agent while entering sensitive information into a separate secure modality, such as a web-page, mobile application, text messaging application, chat session, or using Over-The-Top (OTT) messaging provided by the communication server 56.

While the customer is communicating with the agent, the communication server 56 may transmit the sensitive information to the secure collaboration server 52 over another data channel, or otherwise inform the secure collaboration server 52 that the payment data has been received. In response, the secure collaboration server 52 may transmit data to the agent system 16. This data may cause the agent system 16 to display certain non-sensitive attributes of the sensitive information the customer is entering through the secure modality, and the customer's progress in entering the sensitive information. These non-sensitive attributes may include, for example, that the sensitive information has been provided by the customer, that the sensitive information has been validated, or that payment has been confirmed by the payment system 20.

The multi-modal communications provided by the OLTP system 12 may allow multiple parties to communicate with each other, or with automated systems, across multiple channels simultaneously. For example, the OLTP system 12 may enable the contact center agent and the customer to communicate through a voice channel while the customer interacts with an automated web-page that provides the secure modality for entering payment information. At the same time, the agent may monitor progress over an open modality comprising another web-page.

The web pages providing the secure and open modalities may be hosted by the communication server 56, or by web-servers in communication with the communication server 56. In contrast to co-browsing systems, in which two or more parties access the same web-page at the same time, the OLTP system 12 may provide a separate web-page to each collaborating system. Each web-page may present a different manifestation of the system data, which may be controlled by the OLTP system 12. The agent may thereby monitor what the customer is doing without seeing any sensitive information, and can guide the customer as needed over a separate communication channel. The OLTP system 12 may prompt the customer as needed to correct errors or enter data (e.g., “incorrect zip code entered”) while simultaneously informing the agent regarding progress. The ability of the agent to guide the customer may thereby be improved based on the agent's ability to be updated on the customer's progress.

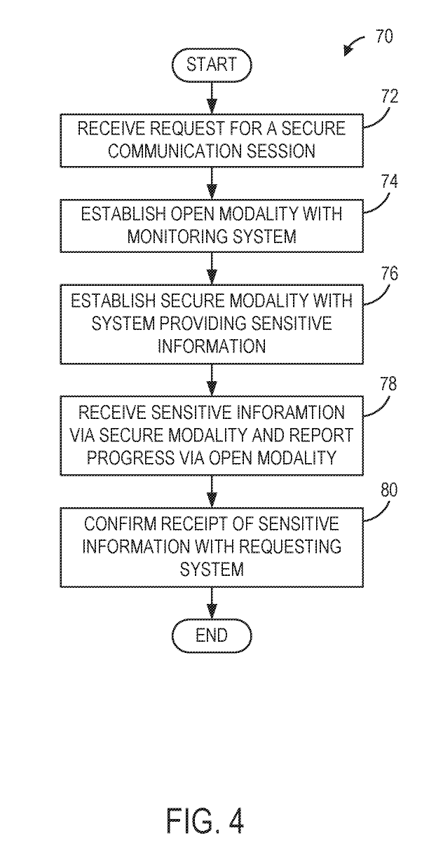

FIG. 4 depicts a flowchart of a secure transaction process 70 that may be implemented by the OLTP system 12. In block 72, the process 70 may receive a request for a secure communication session. The request may include data defining a context of the session, and may be received from the customer system 14, agent system 16, payment system 20, or any other system that may be involved in a secure transaction. The request may be transmitted from the requesting system in response to the requesting system, or a user of the requesting system, determining a need for the secure communication session. This determination may result from, for example, a customer contacting the agent to make a payment on an account, make a claim against an insurance policy, or conduct any other type of transaction that requires the customer to provide sensitive information.

In block 74, the process 70 may establish an open modality with a system that will be used to monitor entry of sensitive information during the secure communication session, such as the agent system 16. The open modality may comprise a communication channel between this system and the OLTP system 12. The communication channel may be established, for example, by the agent logging into a web-page or activating a link provided by the OLTP system 12. In an embodiment of the invention, the open modality may be established as part of the process of requesting the secure communication session. This may occur, for example, if the agent system 16 is both the requesting system and the monitoring system. Under this exemplary scenario, the request for the secure communication session may be received via the open modality after the open modality has been established.

In block 76, the process 70 may establish a secure modality with the system that is to provide the sensitive information, such as the customer system 14. The secure modality may comprise a secure communication channel between the system providing the sensitive information and the OLTP system 12. This secure communication channel may be established, for example, by the OLTP system 12 transmitting a link and/or access code to the customer system 14. The link may connect the customer system 14 to a web-page provided by the OLTP system 12, or that is otherwise in communication with the OLTP system 12. For embodiments in which an access code is provided, the access code may allow the customer system to access a secure web-page provided by the communication server 56. In cases where the customer requests the secure communication session (i.e., the customer system 14 is the requesting system), the secure modality may be established prior to the open modality.

In an embodiment of the invention, the link and/or access code may be configured to expire if the secure communication session is not established within a predetermined period of time. The link and/or access code may also be configured for a single use so that the secure communication session can only be established once using the link and/or access code. Thus, the link and/or access code may become non-functional after it is used to establish the secure modality, or after the predetermined time period has expired without the secure modality being established.

Once the secure modality has been established, the process 70 may proceed to block 78. In block 78, the process 70 may receive the sensitive information via the secure modality, and report out progress to the monitoring system via the open modality. Progress reporting may occur as the sensitive information is received by the secure modality so that the agent can confirm receipt of the data with the customer, or in the case of missing data, direct the customer to populate any unpopulated data fields. For secure modalities in the form of a web-page, the web-page may include data entry fields configured to receive the sensitive information from the customer. These data fields may be populated by the customer entering the data through the user interface of the customer system 14, or may be populated automatically by the customer system 14 based on previously stored information. Automatic population may be based, for example. on information stored in a cookie by a web browser application running on the customer system 14.

As the customer enters the sensitive information, the OLTP system 12 may transmit updates to the agent system 16. An application running on the agent system 16 may display progress notifications to the agent based on these updates, thereby allowing the agent to monitor the customer's progress in providing the sensitive information to the web-page. The information in the updates provided by OLTP system 12 may be limited to general progress reports or status updates, such as “account number entered and validated”, or “incorrect PIN entered” so that sensitive information is not conveyed to the agent system 16. The OLTP system 12 may have secure connections to multiple payment systems and/or secure information databases. The OLTP system 12 may also be configured so that a system administrator can define rules for determining which payment systems to utilize and which secure information databases to update based on customer profile information, metadata received by the OLTP system 12, and/or real time events triggered from the OLTP system 12.

When the all the sensitive information has been received, the process 70 may proceed to block 80 and confirm successful reception of the information with the requesting system. Confirmation may include, for example, querying other systems and/or databases, such as the payment system 20 and/or secure information database 22, to determine the validity of the sensitive information or to confirm that payment has been accepted.

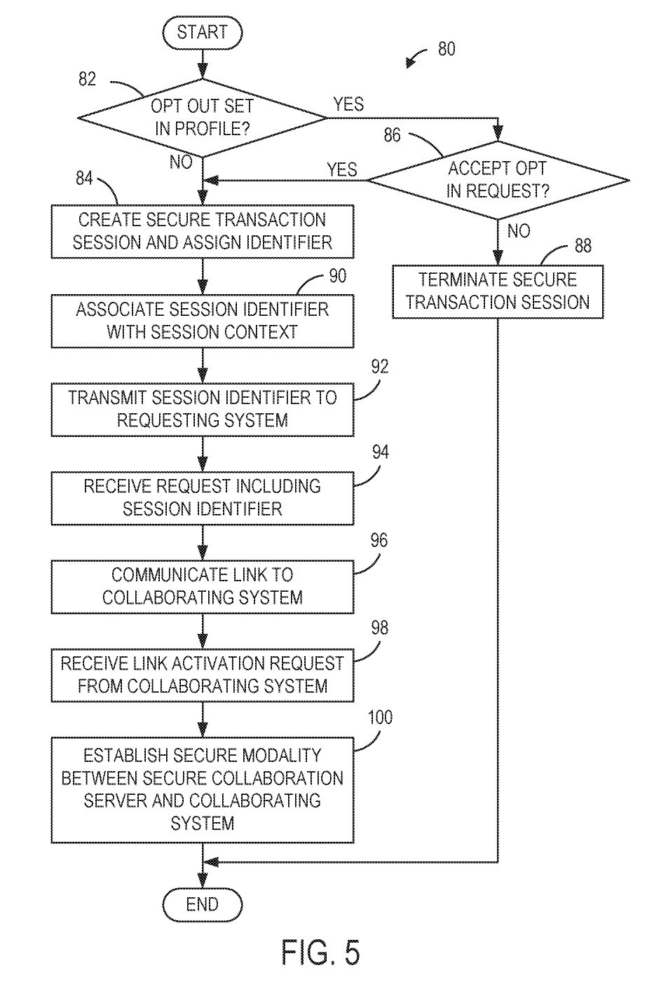

FIG. 5 depicts a flowchart illustrating a process 80 for establishing the secure modality in block 76 of FIG. 4 for an embodiment of the invention. In block 82, the process 80 may determine if the customer has opted out of participating in secure communication sessions. This determination may be made, for example, by querying the profile database 60 for a user profile matching the identity of the customer. If a user profile does not exist, or the user profile exists and does not have the opt-out flag set (“NO” branch of decision block 82), the process 80 may proceed to block 84. If a user profile exists for the customer, and the opt-out flag is set (“YES” branch of decision block 82), the process 80 may proceed to block 86. In an alternative embodiment of the invention, the user profile may be configured to have an opt-in flag rather than an opt-out flag. In this alternative embodiment, the process 80 may proceed to block 84 in response to the opt-in flag being set, or to block 86 in response to the opt-in flag not being set or a user profile not being found.

In block 86, the process 80 may transmit a request to the customer system 14 to determine if the customer is willing to participate in the secure communication session. This request may be transmitted from the communication server 56 to the customer system 14, and may cause, for example, a pop-up window to appear on a browser application running on the customer system 14. If the customer responds that they are not willing to participate in the secure communication session (“NO” branch of decision block 86), the process 80 may proceed to block 88 and terminate the secure communication session. If the customer responds that they are willing to participate in the secure communication session (“YES” branch of decision block 86), the process 80 may proceed to block 84.

In block 84, the process 80 may create a secure communication session in the secure collaboration server 52, and assign a session identifier to the session instance that uniquely identifies the session. The process 80 may then proceed to block 90 and associate the session identifier with a session context. The session context may comprise a database record in the context database 58 for storing session context data. Initial session context data may be provided by the requesting system, such as in a data field of the request for the secure communication session. The session context data may include, for example, a customer account number, a customer name, a phone number of a mobile device used by the customer, and/or an amount due to settle payment. The session context may also store, or otherwise be associated with, the session identifier, and may be used to store data and data attributes created during the secure communication session.

In response to the session instance being created and the session identifier being associated with the session context, the process 80 may proceed to block 92. In block 92, the process 80 may transmit the session identifier to the requesting system. In response to receiving the session identifier, the requesting system may transmit a request to the OLTP system 12 requesting the OLTP system 12 establish a secure modality with the system providing the sensitive information. The request may include the session identifier and data identifying a collaborating system (e.g., an IP address, a web address, email address, phone number, or other electronic address) that is expected to provide sensitive information via the secure modality. The collaborating system may be, for example, the customer system 14.

The session identifier may be transmitted to the collaborating system through any suitable channel, including but not limited to a text message, chat session, email, or as a data field on a web-page. The message may include a one-time use link to a secure web-page that is configured to provide the secure modality. The contact center agent may also trigger the OLTP system 12 to transmit a mobile application “push message” to an application on the collaborating system. The push message may open an application on the collaborating system that accepts payment or other sensitive information from the customer.

In block 94, the process 80 may receive the request to establish the secure modality with the session instance identified by the session identifier. In response to receiving the request, the process 80 may cause the OLTP system 12 to establish communication between the session instance identified by the session identifier and the collaborating system identified in the request. To this end, the process 80 may proceed to block 96 and communicate a link to the collaborating system. The process 80 may communicate the link to the collaborating system, for example, by causing the OPTP system 12 to send a message (e.g., a text message or email) to the collaborating system (e.g., the customer's mobile phone or email address). The message may include a link to a web-page identified by the session identifier. Depending on the session context data and/or the nature of the collaborating system identifier, the process 80 may also send a message to the requesting system informing the system user (e.g., the agent) that the link has been sent. The system user may then contact the user of the collaborating system (e.g., the customer) to notify them that they should be receiving the link, and how the link is being sent.

In block 98, the process 80 may receive a link activation request from the collaborating system. The link activation request may comprise, for example, a request received from a browser application running on the collaborating system that requests the OLTP system 12 open the web-page identified by the link. In response to the link being activated, the process 80 may proceed to block 100 and establish the secure modality between the secure collaboration server 52 and the collaborating system. For embodiments of the invention using a web-page to provide the secure modality, the web-page may be hosted by the communication server 56, and may provide a user interface that the user of the collaborating system can use to provide sensitive information to the secure collaboration server 52.

In some cases, more than two systems may need to exchange data during a secure communication session. Under this scenario, one or more additional collaborating systems may also establish communication with the session instance through a modality provided by the secure collaboration server 52. These additional systems may access their respective modalities by sending a link request including the session identifier to the secure collaboration server 52 in a similar manner as described above. The secure collaboration server 52 may thereby exchange data with multiple collaborating systems by establishing modalities though which each collaborating system can communicate with the secure collaboration server 52. Each modality may have a level of security that is controlled by the SBLC server 54 in dependence on security rules. The security rules may be defined, for example, by a system administrator, may be specific to a particular system or user, and may be stored in a database of security rules (not shown), or some other database, such as the profile database 60. The data exchanged may include data provided by the user of the collaborating system, or that is retrieved from a database maintained by the collaborating system. The exchanged data may also include attributes of the user, the channel, the data being provided, or other metadata.

The secure collaboration server 52 may store data collected during the secure communication session in the secure session context associated with the session identifier. The secure collaboration server 52 may also transmit received data, and changes to the received data, to the SBLC server 54. The SBLC server 54 may process the data, and selectively transmit some or all of the data through the secure collaboration server 52 and/or communication server 56 to selected collaborating systems using the corresponding secure and open modalities. When determining what data to transmit to each collaborating system, the SBLC server 54 may apply the security rules to determine which systems are allowed to process sensitive information. The security rules may thereby prevent sensitive information from being transmitted to a collaborating system that is not authorized to receive the sensitive information.

The OLTP system 12 may enable secure transactions to be established for different reasons and in different ways. In some cases, a secure communication session may be established by collaborating systems in response to determining a transaction involves sensitive information that one or more of the collaborating systems is not authorized to access. For example, in the case of a purchase, one of the collaborating system may request a secure communication session upon determining that a credit card will be used to pay for the purchase. Under this scenario, the secure communication session may be established without any system users requesting the session, or any other prior to involvement of the system users.

In other cases, two or more users may have established a communications channel with each other prior to determining that a secure communication session is needed. Examples of pre-established communication channels may include a voice call or instant messaging session. This scenario may occur, for example, when one user initiates an interaction with another user, such as when a customer calls into a contact center and is connected to a contact center agent. If, during the call, one of the users determines there is a need for a secure communication session, that user may request establishment of a secure communication session. This scenario may occur, for example, if a customer calls into a contact center using a smart phone, and is connected to a contact center agent. If either party decides there is a need for a secure communication session, that party may request the OLTP system 12 establish a secure communication session having a unique session identifier.

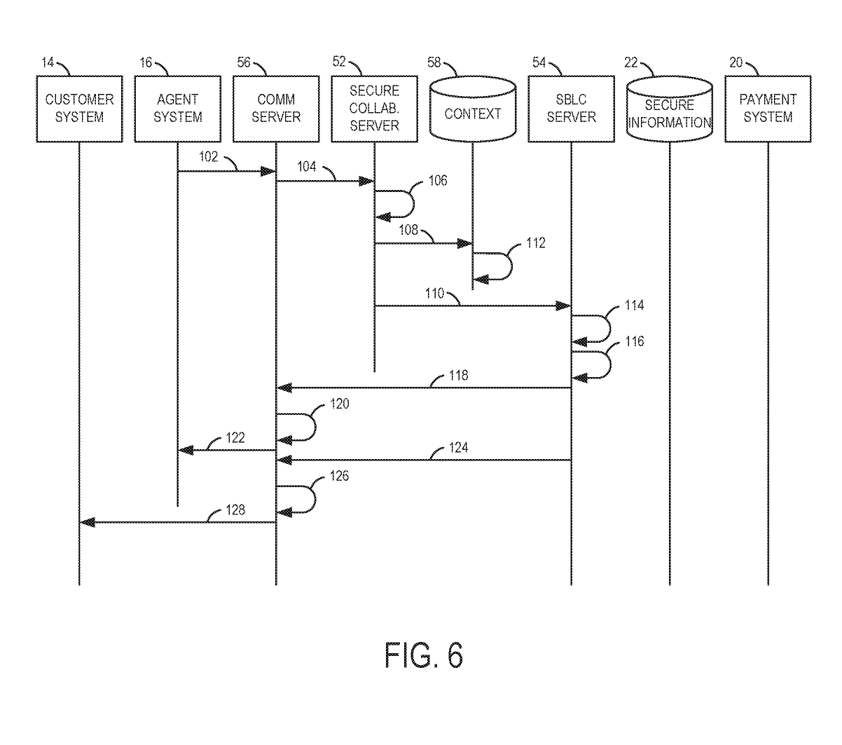

FIGS. 6-8 illustrate exemplary messaging that may occur between the customer system 14, agent system 16, payment system 20, secure information database 22, secure collaboration server 52, SBLC server 54, communication server 56, and context database 58 to establish and manage a secure communication session in an embodiment of the invention.

Under an exemplary usage scenario, a customer may reach a contact center agent by calling into the contact center to make a payment on an account. To assist with the payment, the agent may request a secure communication session using an agent application running on the agent system 16. The agent application may be, for example, a web browser. In response to the agent providing input to the agent application indicating a desire to open a secure communication session, the agent application may transmit a request 102 to the OLTP system 12. The request 102 be received by the communication server 56 of OLTP system 12, and may include session context data.

In response to receiving the request 102, the communication server 56 may transmit a request 104 to the secure collaboration server 52 requesting the secure collaboration server 52 open the secure communication session. In response to receiving the request 104, the secure collaboration server 52 may create a unique session identifier 106, and transmit requests 108, 110 containing the unique session identifier and/or the session context data to the context database 58 and the SBLC server 54, respectively.

In response to receiving the request 108, the context database 58 may create a session context record 112, and associate the record with the session identifier. The context database 58 may then store the session context data in the record, and update the status of the secure communication session in the session context record to indicate that the session identifier has been created.

In response to receiving the request 110, the SBLC server 54 may create modality manager instances for each of the collaborating systems, with each modality manager instance controlling data flow to its respective collaborating system. In the present exemplary case, this may include creating a modality manager instance 114 for the customer system 14, and creating a modality manager instance 116 for the agent system 16.

To create an open modality for use by the agent system 16, the SBLC server 54 may transmit a request 118 to the communication server 56 requesting the communication server 56 create an agent web-page, associate the agent web-page with the session identifier, and transmit a link for the agent web-page to the agent system 16. In response to receiving the request 118, the communication server 56 may create the agent web-page 120, and transmit a message 122 containing the link to the agent system 16. The link may comprise, for example, a Uniform Resource Locator (URL), or hyperlink, that causes the agent application to open the agent web-page.

In response to the agent activating the link, the agent system application may open the agent web-page, thereby establishing the open modality for exchanging data between the agent system 16 and the secure collaboration server 52. In an alternative embodiment of the invention, rather than using a link, the message 122 may cause a pop-up window or other suitable object to display the agent web-page on the agent system 16. In any case, the open modality may be configured so that the agent system 16 receives data that conveys information relating to the sensitive information without conveying the sensitive information itself. Examples of information relating to the sensitive information may include attributes of the sensitive information (e.g., the last four digits of an account number, whether the sensitive information has been received, validated, or used to make a payment), and information indicating a status of the secure communication session. Thus, data received through the open modality may convey information that facilitates assisting the customer without conveying any sensitive information which the agent system 16 is not approved to handle.

The SBLC server 54 may also send a request 124 the communication server 56 requesting the communication server 56 create a customer web-page, associate the customer web-page with the session identifier, and transmit a link to the customer web-page to the customer system 14. In response to receiving the request 124, the communication server 56 may create the customer web-page 126 and transmit a message 128 containing the link to the customer system 14. The customer web-page may be configured to provide a secure modality for exchanging data between the customer system 14 and the OLTP system 12. The message 128 may comprise a text message, email, HTML code, or any other suitable type of message format. In an embodiment of the invention, the message 128 may be a text message sent to the customer's phone that includes a unique embedded URL which opens the customer web-page in a browser application running on the phone.

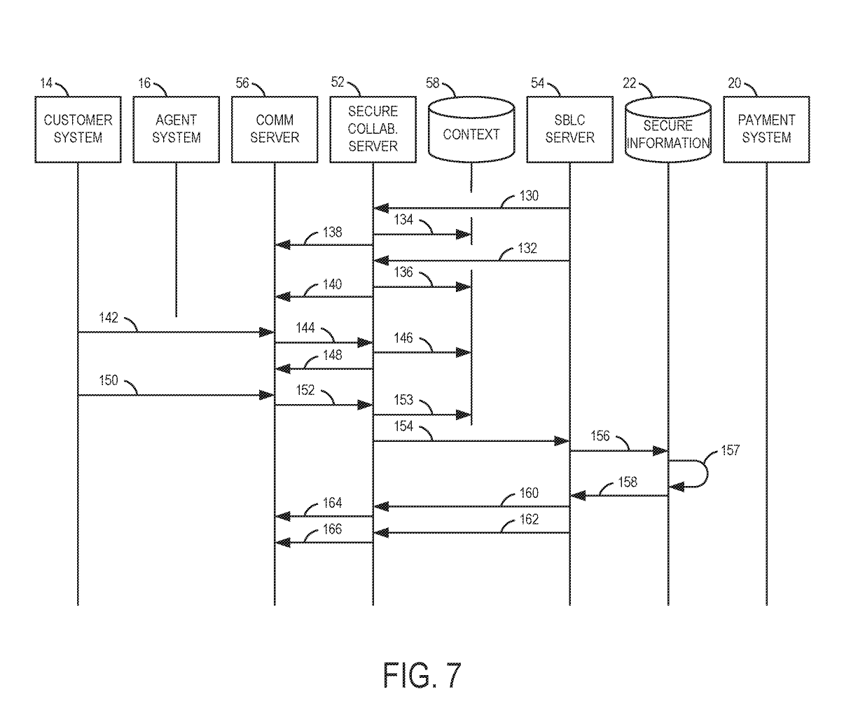

Referring now to FIG. 7, in response to receiving confirmations (not shown) that messages 122 and 128 have been sent and/or received by the customer and agent systems, or that a link has been activated in one of the customer or agent systems, the SBLC server 54 may transmit one or more messages 130, 132 to the secure collaboration server 52. The messages 130, 132 may notify the secure collaboration server 52 of progress relating to the secure communication session. In response to receiving the messages 130, 132, the secure collaboration server 52 may transmit one or more requests 134, 136 to the context database 58 requesting the context database update the session context record to reflect the current status of the secure communication session. In response to receiving the requests, the context database 58 may update the session context record to reflect the current status of the secure communication session. Exemplary statuses may include “session identifier transmitted”, “link received by customer system”, “link activated by customer”, etc. The secure collaboration server 52 may also transmit one or more requests 138, 140 to the communication server 56. The requests 138, 140 may cause the communication server 56 to update the agent web-page to indicate the current status of the secure communication session. The agent may thereby be informed of progress of the secure communication session through the agent web-page.

In response to the customer activating the link transmitted to the customer system 14, the customer system 14 may transmit a request 142 to the communication server 56. The request 142 may include the session identifier, and may request the communication server 56 connect a customer application (e.g., a web browser running on the customer system 14) to the customer web-page associated with the session identifier. The customer web-page may provide a secure modality in the form of a web session through which the customer can enter sensitive information.

In response to receiving the request 142 to activate the link, the communication server 56 may transmit a message 144 to the secure collaboration server 52 notifying the secure collaboration server 52 that the customer system 14 has activated the link. In response, the secure collaboration server 52 may transmit a request 146 to the context database 58, requesting the context database 58 update the session context record to indicate the status of the secure communication session as “secure session initiated”. The secure collaboration server 52 may also transmit a message 148 to the communication server 56, requesting the communication server 56 update a session progress data field in the agent web-page to indicate that the customer has activated the link.

Once the customer web-page is open, the customer system 14 may transmit data 150 that conveys sensitive information to the communication server 56 in response to the customer entering the sensitive information into the secure web-page. For example, the customer may enter payment information into data fields on the customer web-page, and instruct the web-browser to submit the information. As information, sensitive or otherwise, is received from the customer application, the communication server 56 may transmit data 152 to the secure collaboration server 52. In response to receiving the data 152, the secure collaboration server 52 may transmit messages 153, 154 to the context database 58 and SBLC server 54, respectively. In response to receiving the message 153, the context database 58 may update session context stored in the context database 58 to reflect the current status of the secure communication session changes.

In response to receiving message 154, the SBLC server 54 may transmit a query 156 to the secure information database 22 requesting the secure information database 22 validate all or a portion of the information entered by the customer. The secure information database 22 may perform a validation 157 by, for example, comparing the information entered by the customer (e.g., account numbers, card security codes, personal identity numbers, etc.) to corresponding data in secure information database 22. The secure information database 22 may then transmit a reply 158 to the SBLC server 54 indicating the results of the validation 157.

In response to receiving the results of the validation, the SBLC server 54 may transmit requests 160, 162 to the secure collaboration server 52 requesting the secure collaboration server 52 update the agent and customer web-pages in accordance with the results. Communication relating to each collaborating system may be managed by the corresponding modality manager instance in the SBLC server 54. The SBLC server 54 may thereby independently control the data that is provided to each collaborating system based on the security rules.

In response to receiving the requests 160, 162, the secure collaboration server 52 may transmit corresponding requests 164, 166 to the communication server 56. If any of the data provided by the customer system 14 could not be validated, the requests 164, 166 may direct the communication server 56 to update the agent and customer web-pages to identify the error. The customer may then re-enter the information in response to receiving the error message, and/or with guidance from the agent. Each modality manager instance running in SBLC server 54 may select which data is included in the requests 160, 162 in order to control what is ultimately displayed on the agent and customer systems. The OLTP system 12 may thereby update the agent website to indicate the progress and/or attributes of the information being entered by the customer without conveying sensitive information to the agent system 16.

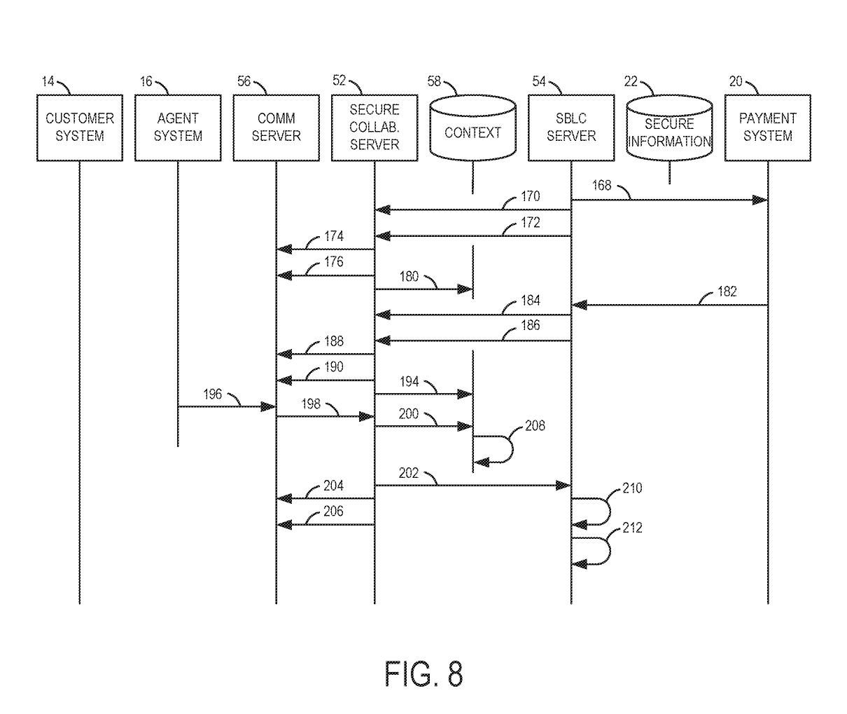

Referring now to FIG. 8, in response to the required payment information being received from the customer system 14 and being validated by the secure information database 22, the SBLC server 54 may transmit a payment request 168 to the payment system 20. The SBLC server 54 may also transmit notifications 170, 172 to the secure collaboration server. The notifications 170, 172 may notify the secure collaboration server 52 that payment has been requested in the payment system 20. In response to receiving the notifications 170, 172, the secure collaboration server 52 may transmit corresponding requests 174, 176 to the communication server 56. The requests 174, 176 may request the communication server 56 update the agent and customer web-pages to show that the payment is being processed or otherwise indicate the current status of the secure communication session. The secure collaboration server 52 may also transmit a requests 180 to the context database 58 requesting the context database 58 update the session context record to indicate that the payment is being processed.

In response to receiving a notification 182 from the payment system 20 that the payment has been completed, the SBLC server 54 may transmit notifications 184, 186 notifying the secure collaboration server 52 that the payment has been successfully posted. In response to receiving the notifications 184, 186, the secure collaboration server 52 may transmit corresponding requests 188, 190 to the communication server 56 and request 194 to the context database 58. In response to receiving the requests 188, 190, 194, the communication server 56 and context database 58 may update the agent and customer web-pages and session context record, respectively, to indicate that the payment has posted.

In response to receiving notification that the payment has been posted, the agent may close the session from the agent web-page. To this end, in response to input provided by the agent, the agent application may transmit a request 196 to close the secure communication session to the communication server 56. In response to receiving the request 196, the communication server 56 may transmit a request 198 to the secure collaboration server 52 requesting that the secure collaboration server close the secure communication session.

To close the secure communication session, the secure collaboration server 52 may transmit notifications 200, 202 to the context database 58 and SBLC server 54. The notifications 200, 202 may notify the context database 58 and SBLC server 54 that the secure communication session is being closed. The secure collaboration server 52 may also transmit requests 204, 206 to the communication server 56. The requests 204, 206 may request the agent and customer web-pages be updated to indicate the secure communication session has been completed.

In response to receiving the notification 200, the context database 58 may modify the session context record 208 by clearing the session context and flagging the session identifier as being associated with a completed session. Flagging the session identifier may prevent the session identifier from being reused, and may provide an additional level of security against fraudsters attempting to access sensitive information by using an expired session identifier. In response to receiving the notification 202, the SBLC server 54 may terminate the session instances 210, 212 for the customer system 14 and agent system 16.

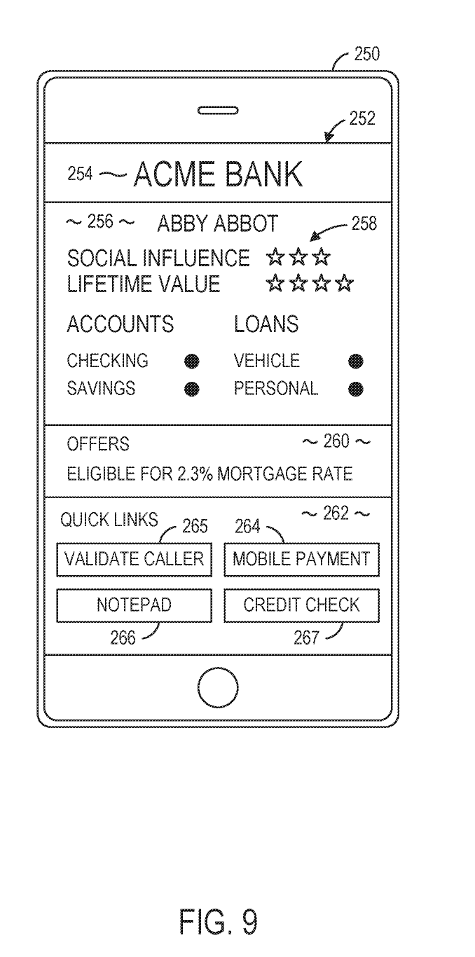

FIGS. 9-16 depict an exemplary embodiment of the invention in which the customer system 14 comprises a mobile device 250. The mobile device 250 may include the customer application (e.g., a mobile browser) that enables the customer to access other systems, such as a web-server operated by a service provider. When the customer application accesses a web-page hosted by the web-server, the web-server may cause the client application to display a user interface provided by the web-page, such as a home page 252 as depicted in FIG. 9. The home page 252 may include an identifier 254 that identifies the service provider (e.g., Acme Bank) with which the customer wishes to transact, and a window 256 that displays customer information 258. The home page 252 may also include a window 260 that displays selected provider information, such as product offers, and a quick links window 262 including a plurality of quick link buttons 264-267. Each of the quick link buttons 264-267 may be configured to navigate the customer application to a new web-page in response to being activated by the customer. For example, if the customer wishes to make a payment, the customer may activate mobile payment button 264.

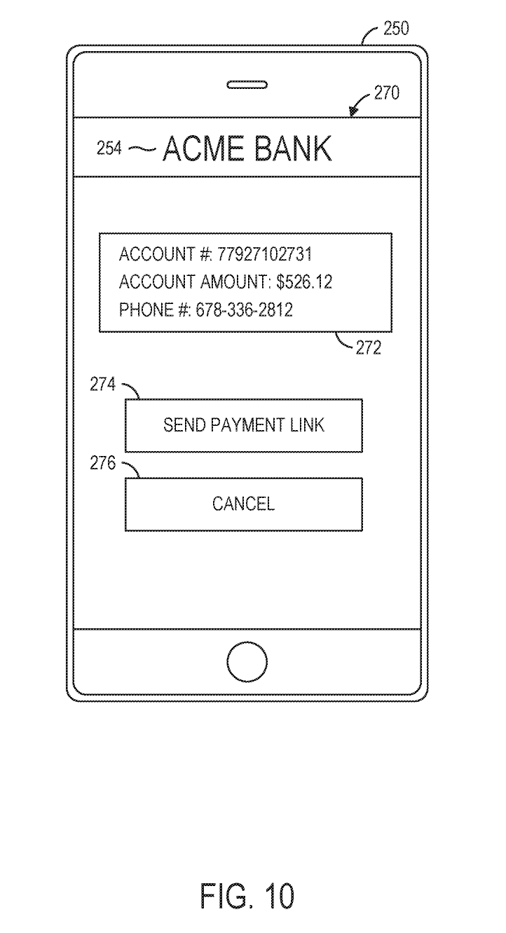

In response to activating the mobile payment button 264, the mobile device 250 may be connected to a mobile payment page such as the exemplary mobile payment page 270 depicted by FIG. 10. The mobile payment page 270 may include an account information window 272 that displays account information, such as an account number, an available balance, and a phone number associated with the account. The mobile payment page 270 may also include a “send payment link” button 274, and a “cancel transaction” button 276. Activating the cancel transaction button may, for example, cause the web-server to cancel the transaction and navigate the customer application back to the home page 252.

Activating the send payment link button 274 may cause the OLTP system 12 to transmit a link to the mobile device 250 that will, when activated, connect the customer application to a secure modality web-page. To this end, in an embodiment of the invention, activating the send payment link button 274 may cause the customer application to transmit data to the communication server 56. This data may trigger the OLTP system 12 to create the session identifier and link, and transmit the link to the mobile device 250.

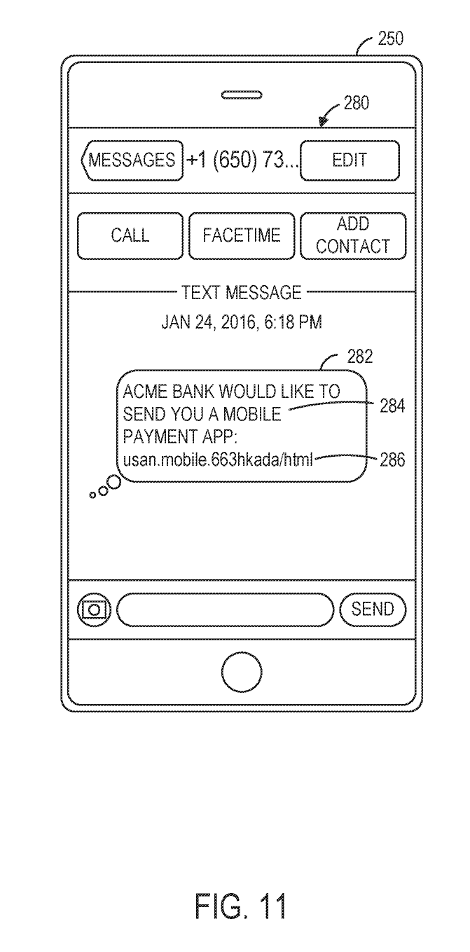

In response to receiving a text message, the mobile device 250 may display a text messaging screen, such as the exemplary text messaging screen 280 depicted by FIG. 11. The text messaging screen 280 may include a text messaging window 282 that displays a message 284 having a link 286 which was transmitted from the OLTP system 12. In response to the customer activating the link 286, the customer application may be connected to the secure modality web-page.

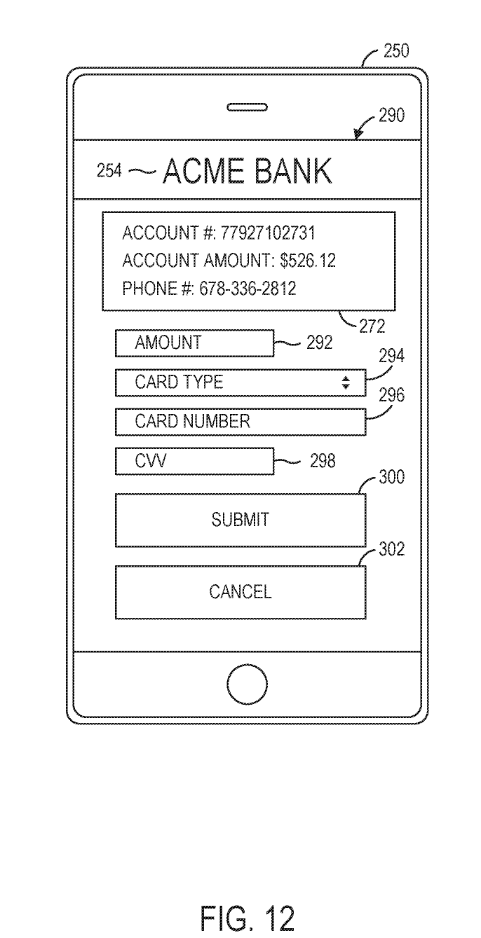

FIG. 12 depicts an exemplary secure modality web-page 290 that may be provided by the communication server 56 or a web server in communication with the communication server 56. The secure modality web-page may include the identifier 254, the account information window 272, and one or more data entry fields. The data fields may include a data entry field 292 for entering a payment amount, a data entry field 294 for selecting a card type, a data entry field 296 for entering a card account number, and a data entry field 298 for entering a Card Verification Value (CVV) or other security code. The secure modality web-page 290 may include a submit data button 300 and a cancel transaction button 302. Activation of the submit data button 300 may cause the data entered into the data entry fields to be transmitted to the OLTP system 12. Activation of the cancel transaction button 302 may cause the OLTP system 12 to cancel the transition.

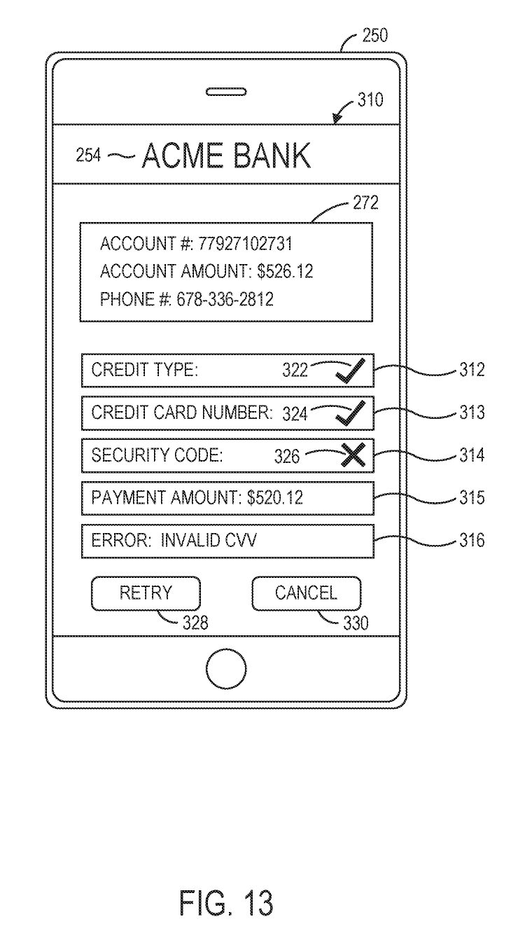

Referring now to FIG. 13, in response to the customer activating the submit data button 300, customer application may be connected to a transaction status web-page 310. The transaction status web-page may display the identifier 254, the account information window 272, and a plurality of read-only data fields 312-316. Exemplary read-only data fields may include a credit type data field 312, a credit card number data field 313, a security code data field 314, and a payment amount data field 315. In cases where the OLTP system 12 is unable to validate all the data entered by the customer, the transaction status web-page may also include an error notification data field 316, a retry button 328 that allows the customer to re-enter invalid data, and a cancel button 330 that allows the customer to cancel the transaction.

One or more of the data fields may also include a status indicator 322, 324, 326 that indicates if the corresponding data was successfully validated. In the present example, the status indicators 322, 324 in the credit type data field 312 and credit card number data field 313 indicate that the OLTP system 12 successfully validated the credit card type and credit card number. However, the status indicator 326 in the security code data field 314 indicates that the OLTP system 12 was unable to validate the CVV entered by the customer.

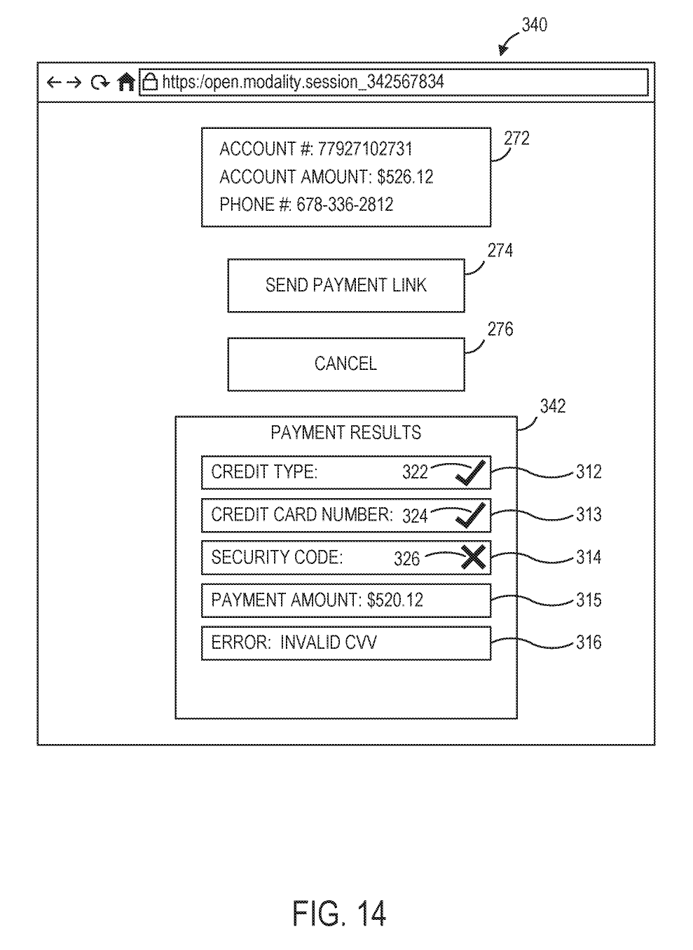

Referring now to FIG. 14, contemporaneously with the transaction status web-page 310 displayed on the customer system 14, the OLTP system 12 may cause a transaction status web-page 340 to be displayed on the agent system 16. The transaction status web-page 340 may include the account information window 272, the send payment link button 274, the cancel transaction button 276, and a payment results window 342. The payment results window 342 may display some or all of the read-only data fields 312-316 displayed by the transaction status web-page 310. The payment results window 342 may thereby keep the agent informed of the customer's progress with regard to entering data.

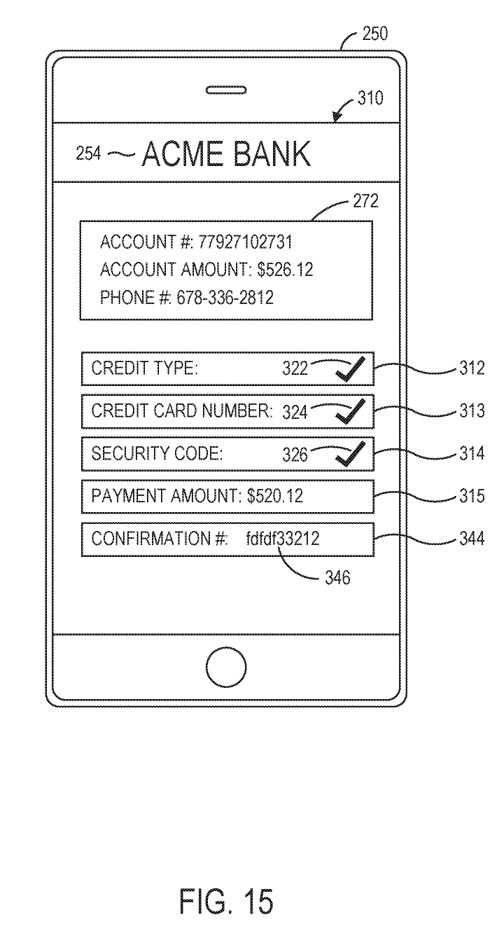

Referring now to FIG. 15, if the OLTP system 12 is able to validate all the data entered by the customer, the transaction status web-page 310 may include a confirmation data field 344 in place of the error notification data field 316. The confirmation data field 344 may indicate that the secure transaction has been successfully completed, and may include a confirmation number 346.

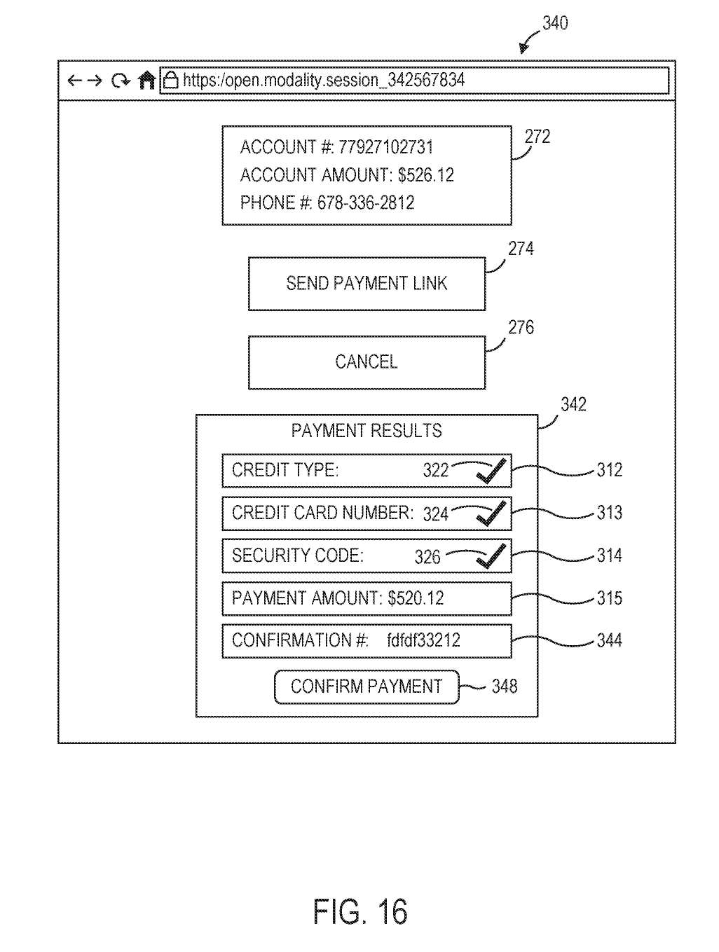

Referring now to FIG. 16, contemporaneously with the transaction status web-page 310 displayed on the mobile device 250, the OLTP system 12 may update the transaction status web-page 340 on the agent system 16. The payment results window 342 may display updated read-only data fields 312-315, 344 and a “confirm payment” button 348. Activating the confirm payment button 348 may, for example, cause the OLTP system 12 to complete and close the secure communication session.

By selectively isolating sensitive information from unsecured computer systems, such as systems used by agents in customer contact centers, embodiments of the invention may allow contact centers to record voice call audio and screen information of a contact center agent without having this monitoring expose secure or confidential information. Secure communication sessions may enable multiple parties to exchange sensitive information, attributes about the information, or information regarding the state of the transaction with each other without compromising the sensitive information. Embodiments of the OLTP system 12 may thereby improve the ability of contact center agents to provide payment processing and collection of sensitive information involving multiple parties without exposing this information to all parties. Embodiments of the OLTP system 12 may also enable secure collaboration for payments collection and processing involving multiple parties using one or more channels, secure processing of payment information after the customer and contact center agent have terminated their call, and secure collection of information from one party even after another party has disconnected from the session.

In general, the routines executed to implement the embodiments of the invention, whether implemented as part of an operating system or a specific application, component, program, object, module or sequence of instructions, or a subset thereof, may be referred to herein as “computer program code,” or simply “program code.” Program code typically comprises computer-readable instructions that are resident at various times in various memory and storage devices in a computer and that, when read and executed by one or more processors in a computer, cause that computer to perform the operations necessary to execute operations and/or elements embodying the various aspects of the embodiments of the invention. Computer-readable program instructions for carrying out operations of the embodiments of the invention may be, for example, assembly language, source code, or object code written in any combination of one or more programming languages.

Various program code described herein may be identified based upon the application within which it is implemented in specific embodiments of the invention. However, it should be appreciated that any particular program nomenclature which follows is used merely for convenience, and thus the invention should not be limited to use solely in any specific application identified and/or implied by such nomenclature. Furthermore, given the generally endless number of manners in which computer programs may be organized into routines, procedures, methods, modules, objects, and the like, as well as the various manners in which program functionality may be allocated among various software layers that are resident within a typical computer (e.g., operating systems, libraries, API's, applications, applets, etc.), it should be appreciated that the embodiments of the invention are not limited to the specific organization and allocation of program functionality described herein.

The program code embodied in any of the applications/modules described herein is capable of being individually or collectively distributed as a program product in a variety of different forms. In particular, the program code may be distributed using a computer-readable storage medium having computer-readable program instructions thereon for causing a processor to carry out aspects of the embodiments of the invention.

Computer-readable storage media, which is inherently non-transitory, may include volatile and non-volatile, and removable and non-removable tangible media implemented in any method or technology for storage of data, such as computer-readable instructions, data structures, program modules, or other data. Computer-readable storage media may further include RAM, ROM, erasable programmable read-only memory (EPROM), electrically erasable programmable read-only memory (EEPROM), flash memory or other solid state memory technology, portable compact disc read-only memory (CD-ROM), or other optical storage, magnetic cassettes, magnetic tape, magnetic disk storage or other magnetic storage devices, or any other medium that can be used to store the desired data and which can be read by a computer. A computer-readable storage medium should not be construed as transitory signals per se (e.g., radio waves or other propagating electromagnetic waves, electromagnetic waves propagating through a transmission media such as a waveguide, or electrical signals transmitted through a wire). Computer-readable program instructions may be downloaded to a computer, another type of programmable data processing apparatus, or another device from a computer-readable storage medium or to an external computer or external storage device via a network.

Computer-readable program instructions stored in a computer-readable medium may be used to direct a computer, other types of programmable data processing apparatuses, or other devices to function in a particular manner, such that the instructions stored in the computer-readable medium produce an article of manufacture including instructions that implement the functions, acts, and/or operations specified in the flow-charts, sequence diagrams, and/or block diagrams. The computer program instructions may be provided to one or more processors of a general purpose computer, a special purpose computer, or other programmable data processing apparatus to produce a machine, such that the instructions, which execute via the one or more processors, cause a series of computations to be performed to implement the functions, acts, and/or operations specified in the flow-charts, sequence diagrams, and/or block diagrams.

In certain alternative embodiments, the functions, acts, and/or operations specified in the flow-charts, sequence diagrams, and/or block diagrams may be re-ordered, processed serially, and/or processed concurrently consistent with embodiments of the invention. Moreover, any of the flow-charts, sequence diagrams, and/or block diagrams may include more or fewer blocks than those illustrated consistent with embodiments of the invention.

The terminology used herein is for the purpose of describing particular embodiments only and is not intended to be limiting of the embodiments of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, actions, steps, operations, elements, and/or components, but do not preclude the presence or addition of one or more other features, integers, actions, steps, operations, elements, components, and/or groups thereof. Furthermore, to the extent that the terms “includes”, “having”, “has”, “with”, “comprised of”, or variants thereof are used in either the detailed description or the claims, such terms are intended to be inclusive in a manner similar to the term “comprising”.

While all of the invention has been illustrated by a description of various embodiments and while these embodiments have been described in considerable detail, it is not the intention of the Applicant to restrict or in any way limit the scope of the appended claims to such detail. Additional advantages and modifications will readily appear to those skilled in the art. The invention in its broader aspects is therefore not limited to the specific details, representative apparatus and method, and illustrative examples shown and described. Accordingly, departures may be made from such details without departing from the spirit or scope of the Applicant's general inventive concept.

What is claimed is:

1. An online transactional processing system comprising:
one or more processors; and
a memory coupled to the one or more processors, the memory storing program code that, when executed by at least one of the one or more processors, causes the online transactional processing system to:
receive a first request to open a secure communication session, the first request identifying a first system from which first information is to be received, the first information including sensitive information;
in response to receiving the first request, establish a first modality with the first system;
establish a second modality with a second system configured to monitor the secure communication session;
receive, from the first system through the first modality, first data conveying the first information; and
transmit, through the second modality to the second system, second data that conveys second information relating to the first information without conveying the sensitive information.

2. The online transactional processing system of claim 1 wherein the program code causes the online transactional processing system to establish the first modality by:
transmitting a first link to the first system; and
in response to receiving third data indicative of the first link being activated by a first application running on the first system, connecting the first application to a second application running on the online transactional processing system,
wherein the first data is received from the first application by the second application.

3. The online transactional processing system of claim 2 wherein the program code causes the online transactional processing system to establish the second modality by:
transmitting a second link to the second system; and
in response to receiving fourth data indicative of the second link being activated by a third application running on the second system, connecting the third application to the second application,
wherein the second data is transmitted to the third application by the second application.

4. The online transactional processing system of claim 1 wherein the program code further causes the online transactional processing system to:
create a session identifier that uniquely identifies the secure communication session;
receive a second request to join the secure communication session from a third system; and
in response to the second request including the session identifier, establish a third modality with the third system.

5. The online transactional processing system of claim 1 wherein the program code further causes the online transactional processing system to:
create a modality manager instance that controls communication through the second modality;
provide the first data to the modality manager instance;
query, by the modality manager instance, a database of security rules for security rules associated with the second system; and
process, by the modality manager instance, the first data to create the second data in accordance with the security rules.

6. The online transactional processing system of claim 1 wherein the program code further causes the online transactional processing system to:
transmit third data conveying the first information to a third system configured to process the first information,
wherein the second data is transmitted to the second system in response to the third system processing the first information, and
the second information is a result of the processing.

7. A method comprising:
receiving, at an online transactional processing system, a first request to open a secure communication session, the first request identifying a first system from which first information is to be received, the first information including sensitive information;
establishing, by the online transactional processing system, a first modality with the first system;
establishing, by the online transactional processing system, a second modality with a second system;
receiving, by the online transactional processing system from the first system through the first modality, first data conveying the first information; and
transmitting, by the online transactional processing system to the second system through the second modality, second data that conveys second information relating to the first information without conveying the sensitive information.

8. The method of claim 7 wherein the first modality is a secure modality, and the second modality is an open modality.

9. The method of claim 7 wherein the second data conveys a status of the first data.

10. The method of claim 7 wherein establishing the first modality comprises:
transmitting a first link to the first system; and
in response to receiving third data indicative of the first link being activated by a first application running on the first system, connecting the first application to a second application running on the online transactional processing system,
wherein the first data is received from the first application by the second application.

11. The method of claim 10 wherein establishing the second modality comprises:
transmitting a second link to the second system; and
in response to receiving fourth data indicative of the second link being activated by a third application running on the second system, connecting the third application to the second application,
wherein the second data is transmitted to the third application by the second application.

12. The method of claim 11 wherein the first and third applications are web browsers, and the second application is a web server.

13. The method of claim 7 further comprising:
in response to receiving the first request, creating a session instance that manages the secure communication session.

14. The method of claim 13 further comprising:
creating a session identifier that uniquely identifies the secure communication session;
associating the session identifier with the session instance;
receiving a second request to join the secure communication session from a third system; and
in response to the second request including the session identifier, establishing, by the session instance, a third modality with the third system.

15. The method of claim 13 further comprising:
creating a modality manager instance that controls communication through the second modality;
providing, by the session instance, the first data to the modality manager instance; and
processing, by the modality manager instance, the first data to create the second data.

16. The method of claim 15 further comprising:
querying, by the modality manager instance, a database of security rules for security rules associated with the second system,
wherein the first data is processed in accordance with the security rules to create the second data.

17. The method of claim 7 further comprising:
transmitting third data conveying the first information to a third system configured to process the first information.

18. The method of claim 17 wherein:
the second data is transmitted to the second system in response to the third system processing the first information, and
the second information is a result of the processing.

19. The method of claim 18 wherein the processing comprises validating the first information, or making a payment using the first information.

20. A computer program product comprising:
a non-transitory computer-readable storage medium; and
program code stored on the non-transitory computer-readable storage medium that, when executed by one or more processors, causes the one or more processors to:
receive a first request to open a secure communication session, the first request identifying a first system from which first information is to be received, the first information including sensitive information;
establish a first modality with the first system;
establish a second modality with a second system;
receive, from the first system through the first modality, first data conveying the first information; and
transmit, through the second modality to the second system, second data that conveys second information relating to the first information without conveying the sensitive information.
